(19) United States
(12) Patent Application Publication
(10) Pub. No.: US 2002/0197465 A1
(43) Pub. Date: Dec. 26, 2002

(54) Damage tolerant CMC using sol-gel martix slurry

(76) Inventors: Steven Carl Butner, Poway, CA (US); Thomas Barrett Jackson, San Diego, CA (US)

Correspondence Address: BROOKS & FILLBACH, 5010 NO. PARKWAY CALABASAS, SUITE 104, CALABASAS, CA, 91302-3913, US

(21) Appl. No.: 10/128,741

(22) Filed: Apr. 22, 2002

Related U.S. Application Data
(60) Provisional application No. 60/286,392, filed on Apr. 24, 2001.

(51) Int. Cl. B32B 17/12

(52) U.S. Cl. 428/293.4

(57) ABSTRACT

Disclosed are an oxide matrix composite that is stable for long-term exposures to temperatures of approximately 1,200° C. and the methods of making the ceramic matrix composite, including wet lay-up, prepreg, and filament winding fabrication methods. The oxide matrix composite can be made using commercially available refractory fibers that retain better than 85% of its original composite strength after 1,000 hours of exposure to such high temperature environments. The preferred alumina-based system demonstrates damage tolerance as relatively high strength retention properties and structural performance. The preferred refractory fibers are commercially available under the tradename of NEXTEL® 720.

### CROSS-REFERENCE TO RELATED APPLICATION

This application claims priority from the following U.S. Provisional Patent Application, the disclosure of which, including all appendices and all attached documents, is incorporated by reference in its entirety for all purposes: U.S. Provisional Patent Application Ser. No. 06/286,392, Steven Carl Butner and Thomas Barrett Jackson entitled, “DAMAGE TOLERANT CERAMIC MATIX COMPOSITE BY WET LAY-UP/PREPREG FABRICATION USING A SOL-GEL MATRIX,” filed Apr. 24, 2001.

### FEDERALLY SPONSORED RESEARCH

The invention was made with Government support under F33615-99-C-5200 awarded by the Department of the Air Force. The Government has certain rights in the invention.

### BACKGROUND

1. Field of the Invention

This invention relates to ceramic matrix composites and more particularly to the production of an oxide-based, fiber-reinforced composite, stable to long term exposure to 1,200° C., using single-iteration, traditional organic composite processing methods, including wet lay-up, prepreg lay-up and filament winding.

2. Description of Prior Art

One generally dichotomizes modern ceramic matrix composites (CMCs) as being either oxide-based or nonoxide-based. The microstructure of an oxide composite can be tailored to yield a microporous matrix that does not require the use of fiber interface coatings in order to produce damage tolerant characteristics. In addition, oxide-based ceramics are inherently more environmentally stable in oxidizing environments than nonoxide-based ceramics and accordingly are well suited for gas turbine engine components such as combustors, transition ducts, vanes and other structures subject to high temperature environments.

In recent years, several oxide-based, damage-tolerant CMCs have been developed. US Pat. No. 5,856,252 to F. F. Lange, et al., assigned to the Regents of the University of California, discloses a totally inorganic slurry transferred into a fiber preform. The preform is then pyrolized to rigidize the preform, and then subsequently reinfiltrated with additional inorganic precursor material. The pyrolozation and reinfiltration steps in the manufacturing process are repeated until the final desired density and porosity of the resulting article are achieved. Even though the matrix is, at its essence, entirely inorganic, repetitive infiltration iterations are required due to the low solids yield of the matrix. The disadvantages of this approach include the need for a fiber preform to which the matrix can be transferred and the need to further densify the matrix through repetitive reinfiltrations to achieve a 70% dense matrix. The requirement for fiber preforms becomes a limitation when the fabrication of complex geometries is considered. In order more economical fabric or fiber tow to be used in this approach, elaborate tooling must be constructed to hold and compress the fiber prior to introduction of the matrix. The preform can also be constructed by having the fiber woven or stitched into a three-dimensional geometry, but this process can greatly increase the relative costs in manufacturing.

U.S. Pat. Nos. 5,488,017 and 5,601,674 to A. Szweda et al., and U.S. Pat. No. 5,306,554 to Harrison, et al., all assigned to General Electric Company, disclose a matrix slurry produced from a silica precursor termed a silicon containing polymer. This organic precursor yields a higher solids matrix therefore allowing composites to be produced in a single step, but the reliance on silica as a binding phase limits the temperature range of the system in use to 1,000-1,100° C. Unfortunately, this temperature capability is too low for many engine components.

U.S. Pat. No. 4,568,594, to A. Hordonneau, at al., assigned to Societe Nationale Industrielle Aerospatiale, discloses a method for producing a refractory alumina matrix, and others, but also relies on a repetitive reinfiltration process to achieve final density and strength.

U.S. Pat. No. 4,461,842, to J. Jamet, assigned to the Office National e'Etudes et de Recherches Aerspatiales, discloses a method for making a CMC in which an ceramic precursor and an organic resin are injected into a fiber preform. As with Hordonneau, this is a transfer molding process using multiple heat/injections cycles to produce the final density and strength.

### SUMMARY

The present invention discloses a method for making a fiber reinforced ceramic matrix composite, stable for sustained service at and around 1,200° C., using low cost composite fabrication methods. The invention disclosed is an oxide-based fiber reinforced composite product, stable under long-term exposure to 1,200° C., using a single-iteration composite wet lay-up or composite prepreg lay-up and processing technique and a method of manufacturing the product. The fabrication cycle is a relatively low cost process cycle that does not require the use of organic-based precursor materials or iterative infiltration or pyrolization cycles to build density and reduce porosity. Rather, the key to the processing approach is the use of a sol-gel derived oxide ceramic matrix. More precisely, the matrix material is a sol-gel-derived alumina, that is reinforced with commercially available oxide fibers including, but not limited to, those sold by 3M under the brand names of NEXTEL® 720, NEXTEL® 650 and NEXTEL® 610. The material system exhibits a unique combination of a versatile single-iteration fabrication process and temperature stability to 1,200° C., a process that can be used to produce cylinders, air foils and other complex shapes at relatively low fabrication costs.

The composite system of the present invention combines the desirable features of both the materials disclosed in Lange, et al., and Szweda, et al., and Harrison, et al., yielding a refractory matrix that can be used to produce a composite in a single processing iteration. In addition, the matrix has been formulated to allow the matrix to either be transferred into a fiber preform, as with the material disclosed by Lange, et al., or laminated via wet lay-up/prepreg processing, as with the material disclosed by Szweda, et al., and Harrison, et al.

An object of the present invention is an article and method of manufacture of an oxide matrix composite using commercially available refractory fibers whereby the composite retains at least 85% of its original composite strength after 1,000 hours of exposure to approximately 1,200° C.

An appreciation of the present invention and a more complete understanding of its structure and method of manufacture may be had by studying the following description of the detailed description with preferred embodiment and by referring to the accompanying drawings.

### BRIEF DESCRIPTION OF THE DRAWINGS

FIG. 1 illustrates the wet lay-up approach of fabricating a complex-shaped component.

FIG. 2A is a perspective view of the slurry infiltration of a subject fabric for the wet lay-up approach.

FIG. 2B is a perspective view of the lay-up of plies on tooling for the wet lay-up approach.

FIG. 2C is a perspective view of the vacuum-bagged CMC ready for lamination in an autoclave or lamination press for the wet lay-up approach.

FIG. 2D is a perspective view of the free-standing post cure of the article resulting from the wet lay-up approach.

FIG. 3 is a perspective view of a portion of the filament winding process.

FIG. 4 is a perspective view of a diptank/pinch roller element of the filament winding process.

FIG. 5 is a perspective view of the mandrel winding of the filament winding process.

FIG. 6 is a graph illustrating the improved thermal stability of the alumina composite system of the present invention over an aluminosilicate matrix CMC of the prior art.

### DETAILED DESCRIPTION OF THE PREFERRED EMBODIMENTS

The matrix of the present invention is produced by combining an alumina sol with a selection of ceramic fillers. The alumina sol is to yield 8-30% weight percent alumina when heated to 1,200° C. The fillers are chosen with particle sizes ranging from 20 nanometers to 1 micron so as to give the resulting aqueous slurry a combination of low shrinkage during drying and firing, and high sinterability. The alumina sol is selected from, or composed of a combination of, aluminum hydroxylchloride, aluminum chloride hexahydrate, alpha aluminum monohydrate, aluminum oxide hydroxide, aluminum hydroxide, and aluminum acetate. Water-soluble organic materials such as cellulose gums, glycols, and vinyl alcohols can then be added to the material as required to yield additional handlability.

The matrix is a viscous, aqueous slurry that is prepregged into the fabric and staged to a tacky consistency. Components are laid-up using organic composite techniques and cured, i.e., dried, using atmospheric pressures of less than 100 psi and temperatures of than 175° C. Composite parts have sufficient strength at this point to be demolded. Of the oxide fibers currently available in the commercial market, NEXTEL® 720 has been found to be the preferred fiber/fabric for this matrix system. The final step required is a free standing pressureless sinter above 1,200° C. to sinter the matrix to final density listed in Table I below providing the pertinent physical properties of A/N720-1 composite reinforced with NEXTEL® 720 fabric (1500D 8HS, 12 ply, 0/90 Lay-up).

TABLE I

| Fiber | NEXTEL ® N720 |
|---|---|
| Fiber Coating | none |
| Matrix | alumina |
| Typical ply thickness, mils | 9.1 |
| Fiber Volume Fraction | 0.46 |
| Bulk Density, (g/cc) | 2.71 |
| Open Porosity, % | 25.4 |
| Maximum Use Temp., continuous, ° C. (° F.) | 1,200 (2,192) |
| Maximum Use Temp., short-term, ° C. (° F.) | 1,300 (2,372) |

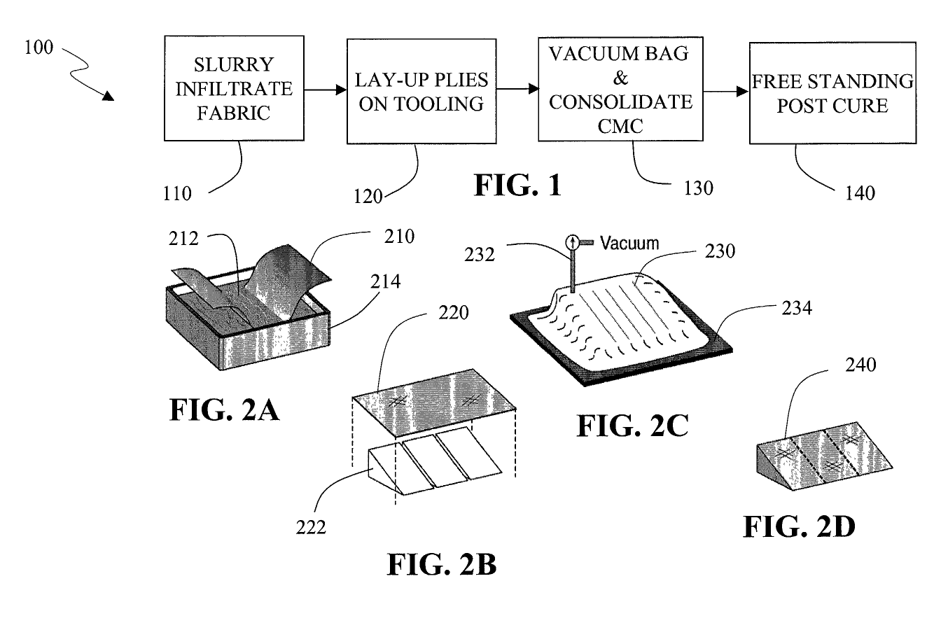

For purposes of appreciating the innovation of the present invention, FIG. 1 illustrates the wet lay-up approach 100 of fabricating a complex-shaped component. First, the fabric is infiltrated with slurry 110, there is a lay-up of plies of fabric upon tooling 120. The plies are consolidated through application of heat (<175C) and pressure (<100 psi) 130 and then the CMC is subject to a freestanding post curing step 140. FIG. 2A illustrates the slurry infiltration 214 of a subject fabric 210 for the wet lay-up approach and FIG. 2B indicates the lay-up of plies 220 onto tooling 222 for the wet lay-up approach. FIG. 2C depicts preparation for pressure lamination in an autoclave by encapsulation of the part in a vacuum bag 232 230 234 for the wet lay-up approach, while FIG. 2D shows the freestanding post cure of the article 240 resulting from the wet lay-up approach.

Prepreg fabrication is distinguished from the wet lay-up approach in that the fabric is impregnated with the matrix staged, and then stored until ready for use. Thus the material, where the fabric and matrix stored in this fashion is designated prepreg, must be stable when properly stored until ready for lay-up. In an illustration of this processing method, the matrix is applied to the fabric either by hand or by a machine. A water impermeable film or bag is placed over and under the prepreg and sealed such that water cannot escape from the prepreg. The material can be stored in this state for period up to 6 months until ready for lay-up. At that point component fabrication proceeds as in the wet lay-up process.

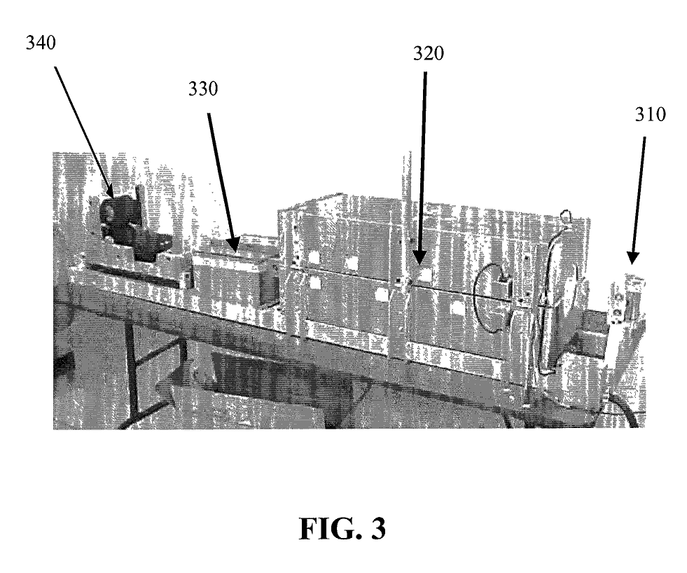

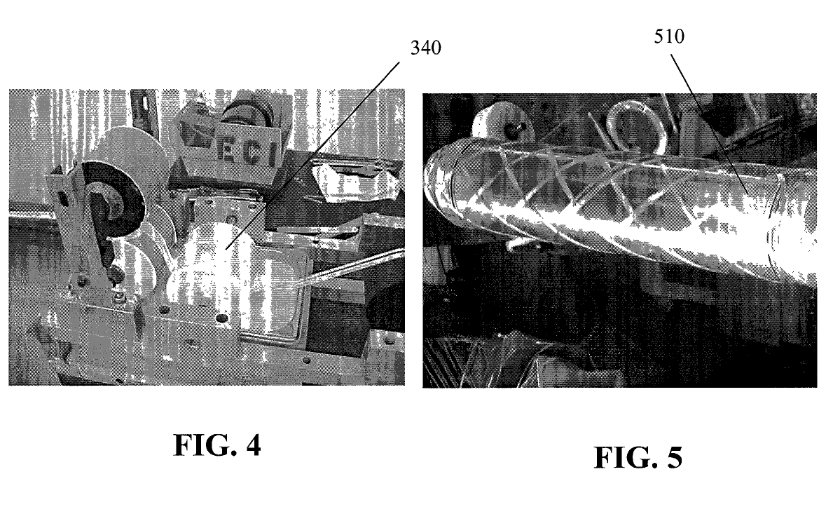

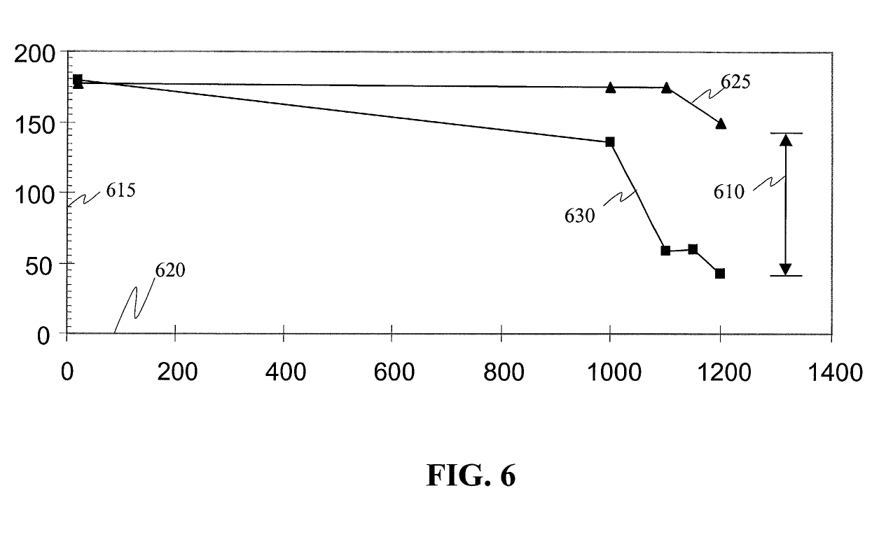

In a filament winding approach, fiber tow, i.e., non-woven fiber, is drawn, as shown in FIGS. 3 and 4, from a spool (not shown) via tow guides 310, run through a tube furnace 320 to remove any organic sizing on the fiber, cooled 330 and then run through a dip tank/pinch roller 340 to saturate and meter the application of matrix to the fiber, and then, as shown in FIG. 5, the fiber is wound onto a mandrel 510, that is typically metal and cylindrical in shape.

Pertinent mechanical, oxidative stability, and thermal properties of A/N720-1 composite reinforced with NEXTEL® 720 Fabric (1500D, 8HS, 0/90 lay-up) are contained in the following Tables IIA-C respectively.

TABLE IIA

| | 20° C. | 1,100° C. | 1,200° C. |
|---|---|---|---|
| MECHANICAL PROPERTIES | (68° F.) | (2012° F.) | (2192° F.) |
| Ultimate Tensile Strength, ksi | 25.8 | 30.3 | 31.8 |
| Tensile Modulus, Msi | 11.4 | 12.3 | 11.0 |
| Tensile Strain-at-Failure, % | 0.32 | 0.35 | 0.38 |
| Interlaminar Tensile Strength, | 0.95 | | |
| ksi | | | |
| Flexure Strength, ksi | 31.6 | | |
| Compressive Strength, in-plane, | 36.7 | | |
| ksi | | | |
| Shear Strength, in-plane, ksi | 5.9 | | |
| Shear Modulus, In Plane, Msi | 3.3 | | |
| Shear Strength, Interlaminar | 1.9 | | |
| (ILS), ksi | | | |
| | Smooth | Sharp | |
| | Notch | Notch | |
| Open Hole Tensile (D/W = 0.25), | 20.5 | 18.0 | |
| Room Temp, ksi | | | |

TABLE II B

| | 1,100° C. & | 1,200° C. & | 1,250° C. & |
|---|---|---|---|
| OXIDATIVE STABILITY | 1,000 hrs | 1,000 hrs | 50 hrs |
| Residual Tensile Strength, | 25.4 | 21.6 | 23.4 |
| ksi | | | |
| Residual Modulus, Msi | 8.6 | 8.7 | 11.1 |
| Creep Rupture Stress/Time | 23/100 | | |
| (1100° C.), ksi/h | | | |
| Creep Rupture Stress/Time | 15/100 | | |
| (1200° C.), ksi/h | | | |

TABLE II C

| | 20° C. | 700° C. | 1200° C. |
|---|---|---|---|
| THERMAL PROPERTIES | (68° F.) | (1292° F.) | (2192° F.) |
| CTE, in-plane, ppm/° C. | 3.5 | 6.0 | 6.0 |
| CTE, thru-thick., ppm/° C. | | | |
| Specific Heat, W-s/gK | 0.76 | 1.24 | 1.34 |
| Thermal Diffusivity, cm²/s | 0.021 | 0.009 | 0.006 |
| Conductivity, in-plane, W/mK | | | |
| Conductivity, thru-thick., W/mK | 4.21 | 2.93 | 2.39 |

The dielectric constant in the 5 to 18 Ghz range of the composite reinforced with NEXTEL® 720 is 5.74.

By way of illustration and not limitation, two examples are disclosed using the method of the present invention.

### EXAMPLE 1

The elements of the viscous slurry of Example 1 are produced by combining, in a ball mill, the constituents shown in the following Table III.

TABLE III

| MATERIAL | Mix Wt % |
|---|---|
| Alumina Sol | 20-40% |
| Fine Alumina | 20-80% |
| Coarse Alumina | 0-40% |
| Organic Processing Aids | 0-20% |
| Nitric Acid (diluted 10:1 | 0-5% |
| with DI water) | |

Where, in the above table, the organic processing aids consist of a combination of one or more of the following: polyvinyl alcohol, methyl cellulose, propylene glycol, ethylene glycol, acacia gum. The fine alumina in the above table have diameters of 0.5 micron or less and the coarse alumina have diameters more than 0.5 micro and less than 1 micron.

The slurry of Example 1 is applied to an oxide fabric. While oxide fabrics such as NEXTEL® 610 and NEXTEL® 650 can be used in the present invention, NEXTEL® 720 1500 Denier 8HS and NEXTEL® 720 3000 Denier 8HS fabric has been found to be a preferred fiber. The prepreg, comprised of fiber and slurry, is then staged to about 80 to 98% of its original weight by allowing water to evolve. Plies of the material are stacked atop one another and laminated using traditional organic composite processing methods. Typical lamination methods include use of an autoclave, a compression mold or a lamination press to apply heat of less than 175° C. and pressure of less than 100 psi. At this point the component made from the material has sufficient green strength, i.e., sufficient strength, cohesiveness and dimensional stability, to be handled and separated from it lamination tooling. The component is then sintered at temperatures of 1,200-1,316° C. This sintering cycle densities and fuses the material together allowing the component to reach its ultimate strength.

### EXAMPLE 2

The elements of the viscous slurry of the Example 2 are produced by combining, in a ball mill, the constituents shown in the following Table IV:

TABLE IV

| Material | Mix Wt % |
|---|---|
| Alumina Sol | 20-40% |
| Fine Alumina | 20-40% |
| Coarse Mullite | 20-40% |
| Organic Processing Aids | 0-20% |
| Nitric Acid (diluted 10:1 with DI water) | 0-5% |

Where, in the above table, the organic processing aids are a combination of one or more of the following: polyvinyl alcohol, methyl cellulose, propylene glycol, ethylene glycol, acacia gum. In the above table, the fine alumina have an average particle diameter of 0.5 micron or less and the coarse mullite has an average particle diameter greater than 0.5 microns and less than 1 micron.

As with the slurry of Example 1, the slurry of Example 2 is applied to an oxide ceramic fabric and NEXTEL® 720 8HS 1500D fabric has been found to be a preferred fiber but other oxide ceramic fabric can be used as well. The prepreg is then staged to 80-98% of its original weight by allowing water to evolve. Plies of the material are stacked atop one another and laminated using traditional organic composite processing methods. Typical lamination methods include use of an autoclave, a compression mold, or a lamination press to apply heat of less than 175° C. and pressure of less than 100 psi. The component made form this material has sufficient green strength to be handled and separated from its lamination tooling. The component is then sintered at temperatures of 1,200-1,316° C. This sintering cycle densifies and fuses the material together allowing the component to reach its ultimate strength.

The oxide-oxide CMC fabrication process for the present invention does not require repetitive re-infiltration or pyrolysis steps. No thin fiber coatings or exterior oxidation protection coatings are required. This lowers the fabrication costs and eliminates coating compatibility and thermal stability problems.

In one example of prior art, the ceramic matrix composite is a sol-gel derived alumino-silicate matrix that can be combined with a variety of commercially available fiber reinforcements such as NEXTEL® 610 and NEXTEL® 720. This silica-alumina system also relies on controlled matrix porosity for toughness, thereby eliminating the need for fiber coatings. Recent findings support the conclusion that high strength, damage tolerant oxide-oxide CMCs can be made without the use of fiber coatings. FIG. 5 illustrates the improved thermal stability 510 as demonstrated by the extended capability of mean retained tensile strength 515 in MPa, after a 1,000 hour aging exposure, across increasing temperature 520 in degrees centigrade, of the alumina composite system 525 over a prior art alumino-silicate matrix composite 530.

The primary advantages of this material over prior art oxide matrix composites is the combination of a versatile low cost process to produce complex composite structures with long term temperature stability to 1200° C. The sol-gel derived alumina matrix has an extremely high solids yield from a slurry which allows production of a 70-80% dense matrix in one processing cycle. This characteristic along with the matrix stability as additional water is removed allows this material to be processed as an organic resin. Thus, common composite fabrication methodologies such as wet lay-up, filament winding, and prepreg lay-up, can be used to produce complex geometries from fabric or fiber tow.

Another advantage of the system is the highly sinterable constituents that make up the slurry. This allows the material to be densified at temperatures low enough to preserve much of the structural integrity of commercially available oxide fibers such as NEXTEL® 720 and NEXTEL® 650.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result.

In addition to the equivalents of the claimed elements, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A ceramic matrix composite comprising:
(a) a fabric comprised of reinforced fibers;
(b) a matrix prepreggable into the fabric; said matrix comprising:
(i) an alumina-yielding precursor selected from the group consisting of aluminum hydroxyl chloride, aluminum chloride hexahydrate, alpha aluminum monohydrate, aluminum oxide hydroxide, aluminum hydroxide, and aluminum acetate; and
(ii) one or more fillers;
wherein the matrix substantially and uniformly penetrates the fabric; and thereafter is curable, laminatable at pressures of less than 100 psi and temperatures less than 175° C., and sinterable at nominal ranges of atmospheric pressure

2. A ceramic matrix composite as claimed in claim 1 wherein said reinforcing fiber is selected from a group consisting of NEXTEL 720 1500 Denier 8HS and NEXTEL 720 3000 Denier 8HS.

3. A ceramic matrix composite as claimed in claim 1, wherein said one or more fillers is fine alumina with an average particle diameter of 0.5 micron or less.

4. A ceramic matrix composite as claimed in claim 1, wherein said one or more fillers are fine alumina with an average particle diameter of 0.5 micron or less and a coarse alumina with an average particle diameter greater than 0.5 micro and less than 1 micron.

5. A ceramic matrix composite as claimed in claim 1, wherein said reinforcement fibers are selected from a group consisting of NEXTEL 312, NEXTEL 550, NEXTEL 610, NEXTEL 720, and NEXTEL 720.

6. A ceramic matrix composite as claimed in claim 1, wherein said one or more fillers is a coarse mullite with an average particle diameter of more than 0.5 micron and less than 1 micron.

7. A ceramic matrix composite as claimed in claim 1, wherein said one or more fillers are fine alumina with an average particle diameter of 0.5 micron or less and a coarse mullite with an average particle diameter greater than 0.5 micron and less than 1 micron.

8. A ceramic matrix composite comprising:
(a) a fabric comprised of reinforced fibers;
(b) a matrix infiltratable into the fabric; said matrix comprising:
(i) an alumina-yielding precursor selected from the group consisting of aluminum hydroxyl chloride, aluminum chloride hexahydrate, alpha aluminum monohydrate, aluminum oxide hydroxide, aluminum hydroxide, and aluminum acetate; and
(ii) one or more alumina fillers;
wherein the matrix substantially and uniformly penetrates the fabric; and thereafter is curable, laminatable at pressures of less than 100 psi and temperatures less than 175° C., and sinterable at nominal ranges of atmospheric pressure

9. A ceramic matrix composite as claimed in claim 8 wherein said reinforcing fiber is selected from a group consisting of NEXTEL 720 1500 Denier 8HS and NEXTEL 720 3000 Denier 8HS.

10. A ceramic matrix composite as claimed in claim 8, wherein said one or more fillers is fine alumina with an average particle diameter of 0.5 micron or less.

11. A ceramic matrix composite as claimed in claim 8, wherein said one or more fillers are fine alumina with an average particle diameter of 0.5 micron or less and coarse alumina with an average particle diameter greater than 0.5 micro and less than 1 micron.

12. A ceramic matrix composite as claimed in claim 8, wherein said reinforcement fibers are selected from a group consisting of NEXTEL 312, NEXTEL 550, NEXTEL 610, NEXTEL 720, and NEXTEL 720.

13. A ceramic matrix composite as claimed in claim 8, wherein said one or more fillers is a coarse mullite an average particle diameter greater than 0.5 micron and less than 1 micron.

14. A ceramic matrix composite as claimed in claim 8, wherein said one or more fillers are fine alumina with an average particle diameter of 0.5 micron or less and a coarse mullite with an average particle diameter greater than 0.5 micron and less than 1 micron.

15. A method of forming an oxide-oxide ceramic matrix composite that comprises the steps of:
combining alumina sol and fine alumina thereby making a slurry;
prepregging the slurry into an oxide fabric thereby making one or more prepreg plies;
staging each prepreg ply to about 80 to 98% of its original weight;
stacking the prepreg plies, one atop one another;
laminating the stacked plies using pressures of less than 100 psi and temperatures less than 175° C. thereby making a laminated component; and
sintering the laminated component at a nominal range of atmospheric pressure thereby making an oxide-oxide ceramic matrix composite.

16. The method of forming an oxide-oxide ceramic matrix composite as claimed in claim 15 further comprising: preceding the step of combining, the step of selecting alumina sol from the group consisting of aluminum hydroxylchloride, aluminum chloride hexahydrate, alpha aluminum monohydrate, aluminium oxide hydroxide aluminum hydroxide, and aluminum acetate.

17. The method of forming an oxide-oxide ceramic matrix composite as claimed in claim 15 wherein the alumina sol is colloidal and selecting is on the basis of surface areas ranging from 100 m²/g to 250 m²/g and average particle sizes ranging from 10 to 500 nanometers.

18. The method of forming an oxide-oxide ceramic matrix composite as claimed in claim 15 wherein the alumina sol is a solution yielding 8-30% weight percent alumina solids when heated to 1,200° C.

19. The method of forming an oxide-oxide ceramic matrix composite as claimed in claim 15 wherein the step of laminating is autoclaving.

20. The method of forming an oxide-oxide ceramic matrix composite as claimed in claim 15 wherein the step of laminating uses a lamination press.

21. The method of forming an oxide-oxide ceramic matrix composite as claimed in claim 15 wherein the step of laminating uses a compression mold whereby the plies are placed and laminated within the compression mold.

22. The method of forming an oxide-oxide ceramic matrix composite as claimed in claim 15, the method further comprising: (a) preceding the step of laminating, the step of affixing the plies to lamination tooling; and (b) preceding the step of sintering, the step of removing the laminated component from the lamination tooling.

23. The method of forming an oxide-oxide ceramic matrix composite as claimed in claim 22, wherein the step of combining alumina sol and fine alumina further comprises the step of combining coarse alumina with said alumina sol and said fine alumina.

24. The method of forming an oxide-oxide ceramic matrix composite as claimed in claim 22, wherein the step of combining alumina sol and fine alumina further comprises the step of combining coarse mullite with said alumina sol and said fine alumina.

25. The method of forming an oxide-oxide ceramic matrix composite as claimed in claim 22, wherein the step of combining alumina sol and fine alumina further comprises the step of combining diluted nitric acid with said alumina sol and said fine alumina.

26. The method of forming an oxide-oxide ceramic matrix composite as claimed in claim 22, wherein the step of combining alumina sol and fine alumina further comprises the step of combining with said alumina sol, and said fine alumina, organic processing aids selected from a group consisting of polyvinyl alcohol, methyl cellulose, propylene glycol, ethylene glycol and acacia gum.

27. The method of forming an oxide-oxide ceramic matrix composite as claimed in claim 22, wherein the oxide fabric is comprised of reinforcement fiber selected from a group consisting of NEXTEL 312, NEXTEL 550, NEXTEL 610, NEXTEL 650, and NEXTEL 720.

28. The method of forming an oxide-oxide ceramic matrix composite as claimed in claim 22, wherein the oxide fabric is comprised of NEXTEL 720 reinforcement fiber

29. The method of forming an oxide-oxide ceramic matrix composite as claimed in claim 22, wherein the step of laminating is effected at pressures of less than 100 psi and temperatures less than 175° C.

30. A method of forming an oxide-oxide ceramic matrix composite that comprises the steps of:
combining alumina sol and fine alumina thereby making a slurry;
infiltrating an oxide fabric with the slurry thereby making one or more wet lay-up plies;
staging each wet lay-up ply to about 80 to 98% of its original weight;
stacking the wet lay-up plies, one atop one another;
laminating the stacked plies using pressures of less than 100 psi and temperatures less than 175° C. thereby making a laminated component; and
sintering the laminated component at a nominal range of atmospheric pressure thereby making an oxide-oxide ceramic matrix composite.

31. The method of forming an oxide-oxide ceramic matrix composite as claimed in claim 30 further comprising: preceding the step of combining, the step of selecting alumina sol from the group consisting of aluminum hydroxylchloride, aluminum chloride hexahydrate, alpha aluminum monohydrate, aluminium oxide hydroxide aluminum hydroxide, and aluminum acetate.

32. The method of forming an oxide-oxide ceramic matrix composite as claimed in claim 30 wherein the alumina sol is colloidal and selecting is on the basis of surface areas ranging from 100 m²/g to 250 m²/g and average particle sizes ranging from 10 to 500 nanometers.

33. The method of forming an oxide-oxide ceramic matrix composite as claimed in claim 30 wherein the alumina sol is a solution yielding 8-30% weight percent alumina solids when heated to 1,200° C.

34. The method of forming an oxide-oxide ceramic matrix composite as claimed in claim 30 wherein the step of laminating is autoclaving.

35. The method of forming an oxide-oxide ceramic matrix composite as claimed in claim 30 wherein the step of laminating uses a lamination press.

36. The method of forming an oxide-oxide ceramic matrix composite as claimed in claim 30 wherein the step of laminating uses a compression mold whereby the plies are placed and laminated within the compression mold.

37. The method of forming an oxide-oxide ceramic matrix composite as claimed in claim 30, the method further comprising: (a) preceding the step of laminating, the step of affixing the plies to lamination tooling; and (b) preceding the step of sintering, the step of removing the laminated component from the lamination tooling.

38. The method of forming an oxide-oxide ceramic matrix composite as claimed in claim 30, wherein the step of combining alumina sol and fine alumina further comprises the step of combining coarse alumina with said alumina sol and said fine alumina.

39. The method of forming an oxide-oxide ceramic matrix composite as claimed in claim 30, wherein the step of combining alumina sol and fine alumina further comprises the step of combining coarse mullite with said alumina sol and said fine alumina.

40. The method of forming an oxide-oxide ceramic matrix composite as claimed in claim 30, wherein the step of combining alumina sol and fine alumina further comprises the step of combining diluted nitric acid with said alumina sol and said fine alumina.

41. The method of forming an oxide-oxide ceramic matrix composite as claimed in claim 30, wherein the step of combining alumina sol and fine alumina further comprises the step of combining with said alumina sol, and said fine alumina, organic processing aids selected from a group consisting of polyvinyl alcohol, methyl cellulose, propylene glycol, ethylene glycol and acacia gum.

42. The method of forming an oxide-oxide ceramic matrix composite as claimed in claim 30, wherein the oxide fabric is comprised of reinforcement fiber selected from a group consisting of NEXTEL 312, NEXTEL 550, NEXTEL 610, NEXTEL 650, and NEXTEL 720.

43. The method of forming an oxide-oxide ceramic matrix composite as claimed in claim 30, wherein the oxide fabric is comprised of NEXTEL 720 reinforcement fiber

44. The method of forming an oxide-oxide ceramic matrix composite as claimed in claim 30, wherein the step of laminating is effected at pressures of less than 100 psi and temperatures less than 175° C.

45. A method of forming an oxide-oxide ceramic matrix composite that comprises the steps of:
combining alumina sol and fine alumina thereby making a slurry;
wet winding oxide filament with the slurry about a fixture, thereby making one or more wet filament winding plies;
stacking the wet filament winding plies, one atop one another;
laminating the stacked plies using pressures of less than 100 psi and temperatures less than 175° C. thereby making a laminated component; and
sintering the laminated component at a nominal range of atmospheric pressure thereby making an oxide-oxide ceramic matrix composite.

46. The method of forming an oxide-oxide ceramic matrix composite as claimed in claim 45 further comprising: preceding the step of combining, the step of selecting alumina sol from the group consisting of aluminum hydroxylchloride, aluminum chloride hexahydrate, alpha aluminum monohydrate, aluminium oxide hydroxide aluminum hydroxide, and aluminum acetate.

47. The method of forming an oxide-oxide ceramic matrix composite as claimed in claim 45 wherein the alumina sol is colloidal and selecting is on the basis of surface areas ranging from 100 m²/g to 250 m²/g and average particle sizes ranging from 10 to 500 nanometers.

48. The method of forming an oxide-oxide ceramic matrix composite as claimed in claim 45 wherein the alumina sol is a solution yielding 8-30% weight percent alumina solids when heated to 1,200° C.

49. The method of forming an oxide-oxide ceramic matrix composite as claimed in claim 45 wherein the step of laminating is autoclaving.

50. The method of forming an oxide-oxide ceramic matrix composite as claimed in claim 45 wherein the step of laminating uses a lamination press.

51. The method of forming an oxide-oxide ceramic matrix composite as claimed in claim 45 wherein the step of laminating uses a compression mold whereby the plies are placed and laminated within the compression mold.

52. The method of forming an oxide-oxide ceramic matrix composite as claimed in claim 45, the method further comprising: (a) preceding the step of laminating, the step of affixing the plies to lamination tooling; and (b) preceding the step of sintering, the step of removing the laminated component from the lamination tooling.

53. The method of forming an oxide-oxide ceramic matrix composite as claimed in claim 45, wherein the step of combining alumina sol and fine alumina further comprises the step of combining coarse alumina with said alumina sol and said fine alumina.

54. The method of forming an oxide-oxide ceramic matrix composite as claimed in claim 45, wherein the step of combining alumina sol and fine alumina further comprises the step of combining coarse mullite with said alumina sol and said fine alumina.

55. The method of forming an oxide-oxide ceramic matrix composite as claimed in claim 45, wherein the step of combining alumina sol and fine alumina further comprises the step of combining diluted nitric acid with said alumina sol and said fine alumina.

56. The method of forming an oxide-oxide ceramic matrix composite as claimed in claim 45, wherein the step of combining alumina sol and fine alumina further comprises the step of combining with said alumina sol, and said fine alumina, organic processing aids selected from a group consisting of polyvinyl alcohol, methyl cellulose, propylene glycol, ethylene glycol and acacia gum.

57. The method of forming an oxide-oxide ceramic matrix composite as claimed in claim 45, wherein the oxide fabric is comprised of reinforcement fiber selected from a group consisting of NEXTEL 312, NEXTEL 550, NEXTEL 610, NEXTEL 650, and NEXTEL 720.

58. The method of forming an oxide-oxide ceramic matrix composite as claimed in claim 45, wherein the oxide fabric is comprised of NEXTEL 720 reinforcement fiber

59. The method of forming an oxide-oxide ceramic matrix composite as claimed in claim 45, wherein the step of laminating is effected at pressures of less than 100 psi and temperatures less than 175° C.
